(19) United States
(12) Patent Application Publication
(10) Pub. No.: US 2006/0093155 A1
(43) Pub. Date: May 4, 2006

(54) Interface enhancement apparatus

(76) Inventors: David Fiori JR., Yardley, PA (US); Victor Chavez, North Hollywood, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/980,883

(22) Filed: Nov. 3, 2004

(51) Int. Cl. H04B 1/00

(52) U.S. Cl. 381/86

(57) ABSTRACT

An interface enhancement apparatus that increases the utility of devices that translate digital commands intended for a device with certain limitations in terms of the user specification of at least one control parameter to expand the ability of a user to specify the control parameter from a larger range of values than the source digital commands are intrinsically capable of specifying.

### FIELD OF THE INVENTION

The present invention relates to audio systems and in particular to an interface enhancement apparatus for an automobile audio system.

### BACKGROUND OF THE INVENTION

Automobile audio systems are commonly equipped with a user interface device mounted within convenient reach of the driver, a device usually referred to as the Head unit, which is often equipped to control remote compact disc changers referred to as CD changers. Accordingly, they permit the user to specify parameters such as the disc number to play, the track number of the selected disc to play, and various mode selection features such as track repeat, scan and shuffle. These parameters are ordinarily submitted to the remote compact disc player which, for example, responds to fetch the given disc and place it into a CD reading mechanism which then searches for the specified track number. Because CDs are limited by the definition of their digital storage formats to no more than 99 tracks, the user interface devices used to control them do not ordinarily display numbers beyond the range of 1-99. As the popularity of Compact Discs (CDs) remains significant, manufacturers of automobiles continue to equip their vehicles with head units that are able to control remote CD changers.

In contrast, new types of audio players are emerging with the ability to store and play thousands of tracks with high fidelity equal to that of the said CDs. Such players have been developed with the ability to remotely control which of such thousands of tracks they play. Unfortunately, the ordinary translation of the digital control protocols employed by ordinary head units to control CD changers could not normally provide for specifying or displaying the large number of tracks that such new types of audio players are able to select.

The present invention could also be applied to utilizing the track control protocol to select among multiple auxiliary audio players. Other applications of the present invention directed to the control of additional interface related parameters will occur to those of ordinary skill in the art.

While the present invention is described within the scope of audio players, the invention may also be applied to other media connections such as video or satellite radio sources.

BMW, an original manufacturer of automobiles (OEM) in cooperation with Apple Computer, Inc. has developed a device that provides for access to more than 99 tracks on an Apple iPod with the head units BMW normally provides with their automobiles. These head units were designed to remotely control a compatible CD changer that BMW sells and which is able to intrinsically address only 99 tracks. BMW addresses the possibility of greater numbers of tracks that are possible with an Apple ipod by permitting “roll over” when incrementing beyond the 99 tracks the BMW head unit is able to display. Roll over occurs when the track number is advanced past 99 as the user presses the track up button on the BMW head, and while the actual track number of the song selected in the Apple iPod continues to increase, the BMW display starts over from 1 since BMW head units have only two digits to display. In this way tracks greater than 99 may be selected, but the user must remember how many such roll overs occur, mentally multiply the number of roll overs by 99 and then add the current track number displayed to arrive at the actual track number currently playing on the Apple iPod. This is a relatively complicated process, and requires the user to remember roll overs in order to arrive at the actual track number. In addition, the BMW device permits the specification of large number of tracks more rapidly by incrementing the track number by 10 instead of 1 when the track up or track down buttons are pressed and held. BMW refers to this function as the “Track Search (x10)” playback option. These playback enhancements are described in the BMW iPOD Owners Manual, copyright 2004, page 17. Such a feature that makes quicker navigation among many possible tracks by advancing the track selection change by ten times is desirable, but unfortunately most OEM head units only signal the fact that the button was pushed, or worst, signal only the consequences of the button's press in the form of a track command that commands their changers to play a specific track number. Such head units do not relay enough information via their remote control interfaces to signal that the track button was held for at least a certain period of time, and so it is not possible for a protocol translator to implement such features in connection with most other OEM head units.

Blitzsafe, a manufacturer of devices that translate digital protocol between head units and CD changes has submitted application number 2003/0215102 which purports to teach a method for the selection of different sources. At paragraph 94, Blitzsafe explains the use of a user entered sequence comprised of the press of a track up button immediately followed by the press of a track down button to toggle between two different modes of operation. The Blitzsafe device interprets such a sequence as a command to select an alternate mode of operation to enable the selection of one of a number of different auxiliary sources by alternatively responding to disc selection commands resulting from the user's pressing of disc number select buttons as auxiliary source select commands. That document describes the use of a rapid sequence of a track up button quickly followed by a track down button to engage an alternative interpretation of a subsequent disc select command as an auxiliary device selection command.

Use of the track up and down buttons as Blitzsafe described to engage an alternate mode of interpretation is awkward when selecting a track from a large number of tracks. This technique would create a problem when users might try to rapidly track down after a series of track ups might have over stepped the track number the user desires. The user would then become confused as the alternate mode of command interpretation would take effect when a track down was actually desired and expected. The apparatus Blitzsafe described will also delay the response time of a sequence of multiple track up commands. The logic described by Blitzsafe to detect such a key stroke sequence will hold off the track up action while the devices waits some 750 milliseconds for the possible entry of a track down command as described in FIG. 5, block 304 of the Blitzsafe patent application. As users will want to navigate among large number of tracks in connection with modern audio players, such logic timing will require an inordinate amount of time to navigate over a large number of tracks.

### SUMMARY OF THE INVENTION

The present invention increases the utility of devices that translate digital commands intended for a device with certain limitations in terms of the user specification of at least one control parameter in such as way to expand the ability of a user to specify the control parameter from a larger range of values than the source digital commands are intrinsically capable of.

This is done in the present invention by establishing an alternate mode of operation when the translator identifies a special sequence of user key strokes. Once the alternate mode of operation is entered, the ordinary interpretation of commands can be altered to more quickly specify a given parameter such as the track number, or provide for the selection of different ranges of a parameter using the head unit protocol to select a scaled offset for that parameter. For example, the two decimal digits of track selection protocol that ordinarily enable only the selection of track 01 to track 99 could be interpreted to instead select from among a set of up to 99 track number offsets. For example, track number offsets from 0 to 9,702 corresponding to selections of track 01 to 99 could be selected without violating the ordinary command protocol of the head unit. In this way the protocol requirements of the head can be met and the limited display capabilities of the head unit applied to ultimately select up to 9,801 tracks. Moreover, once such an alternate mode of operations is entered, additional alternate modes of operation could also be specified to provide additional specification capabilities as any or all subsequent commands could be enhanced in different ways. Moreover, the alternative interpretation of commands could enable additional alternate modes of interpretation or disable the current alternative mode.

The use of commands corresponding to buttons that specify parameters other than those that are used to specify a numeric address to engage the alternate mode of command interpretation provides additional benefits especially when that command results in an indication of the state of that parameter on the display of the head unit. Because such commands may be independent of the track number protocol, and since many such commands operate in a toggle mode in their normal use, they may be quickly pressed twice without any adversely effecting the remote control protocol. Is many cases the first press would command the engagement of the corresponding function while the second press would normally command the disengagement of that function without requiring any other change in system state. In such cases the rapid pressing of such a button twice in rapid succession would normally result in no change in the specification of the function or parameter associated with the button as far as the head unit would be concerned in accordance with the head unit's remote control protocol. Buttons for track scan, shuffle or random mode, and repeat are often provided by OEM head units, and such buttons often act exactly that way. Other features of different OEM head units may also be engaged in that way. While the head would not expect any change in system state, the device that implements this current invention would interpret the unusually rapid sequence as a command to engage an alternate mode.

Once the system adopts the alternate mode, every command possible could be interpreted in an alternative way without any violation of the head unit's normal protocol. For example, the track up and down buttons could result in incrementing or decrementing the track by ten tracks instead of the normal 1 track at a time. In particular, the same toggle mode button could be engaged by a third press which the normal head unit protocol would treat as a function engagement. Because most head units indicate the status of such modes to the user, the user would have the benefit of display feedback relating to the engagement of such an alternative function mode. Such an alternative function mode could then shift the numbers relayed to be displayed by the track number display of the head unit, in addition to shifting its interpretation of the track control buttons to operate on the selection of an offset instead of the actual track number.

Offsets that are multiples of the number of tracks the normal protocol and display facilities the head unit's system is able to handle can be selected this way. For example, the specification of 1 in this mode could correspond to an offset of 0, and the specification of 2 would then correspond to a selection of an offset of 99, 3 would correspond to 99×2=198, on up to 99 which would correspond to 99×99=9,801 total selectable tracks for a system whose protocol would allow only the specification of 1 to 99 for the track number. These offsets could be referred to as “banks” and the track number protocol in this alternate mode would be interpreted by the translator as the selected “bank” number. Said “banks” could then be selected using the normal track selection protocol supported by the head unit.

Head units with two digit displays that can display 00-99 are preferred since they are able to select up to 100 tracks. Banks of 100 tracks are preferred because the two digit track number specification in the bank select mode would simply be specifying thousands and hundreds of the offset. In this way the user need only concatenate the 2 decimal digits specified in the bank select mode with the 2 decimal digits that appear in the normal track selection mode to specify an address with the full range of 4 decimal digits.

Once an alternate mode of operation is implemented, other head unit commands could also be interpreted in different ways. For example, a shuffle or random mode engagement command from the head unit could alternatively specify a mode in which a number of different audio players could be chosen from.

For Head units that cannot display zero (0,) the utility of this invention may be increased by the method of using one of the normal track number display values twice so that 100 tracks may be selected even though the display is able to indicate only 99 tracks. One way of accomplishing this is that the value one (1) could be used twice, once to specify the value 100 and second, the value 101. For example the display of one (1) would be made to appear on the head unit display to specify 100 after responding to a track up command when track 99 was previously selected. Moreover, the display would continue to display one (1) after the system responds to a second track up command in this example as the system acts to play track number 101. Alternatively, but in a similar manner, the value of 99 can be used twice, first to specify 99, and then to specify 100. This same logic could also be applied to specifying the bank number to permit the selection of 100 banks yielding the possibility of selecting up to 100 tracks per bank times 100 banks which amounts to a total of 10,000 tracks while always satisfying protocol and head unit displays designed to handle only 99 tracks.

### BRIEF DESCRIPTION OF THE DRAWINGS

FIGS. 1 to 4 are block diagrams of the prior art.

FIG. 5 is a block diagram of the preferred embodiment of the present invention.

FIG. 6 is a schematic of the digital electronics typically used to interface a user interface device such as a car stereo head unit to a modern digital audio player.

FIGS. 7a to 7g are a flow chart outlining the preferred embodiment.

FIGS. 8a to 8c are a flowchart of the track command protocol of the invention.

### DETAILED DESCRIPTION OF THE INVENTION

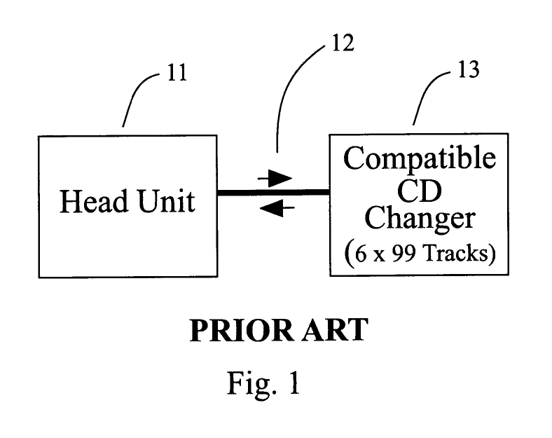

FIG. 1 illustrates the remote control connection between a user interface device such as a car stereo head unit 11 and a compatible compact disc changer 13 via signal and control communications transmitting means 12. This figure is illustrative of the type of system to which the present invention may be applied.

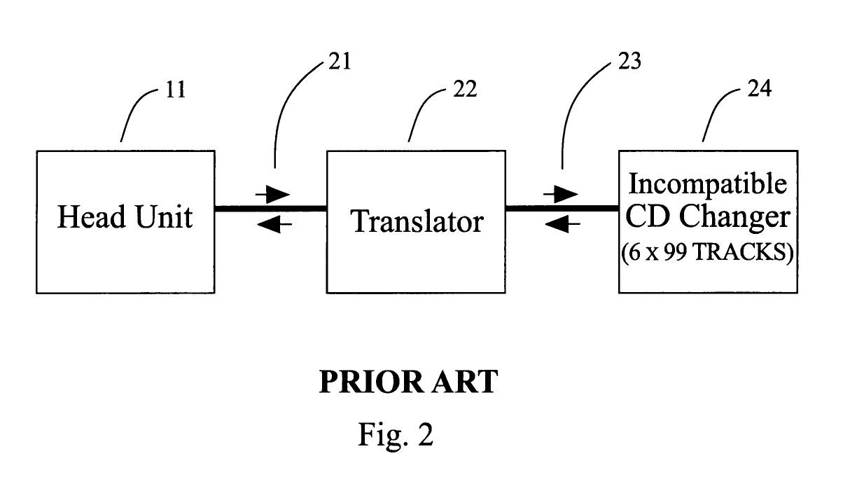

FIG. 2 illustrates the connection between a head unit 11, an interfacing device 22 such as is exemplified by the present invention, and an external device 24 such as a normally incompatible CD Changer not requiring any enhanced control capabilities such as a CD changer or a relatively small capacity digital audio player.

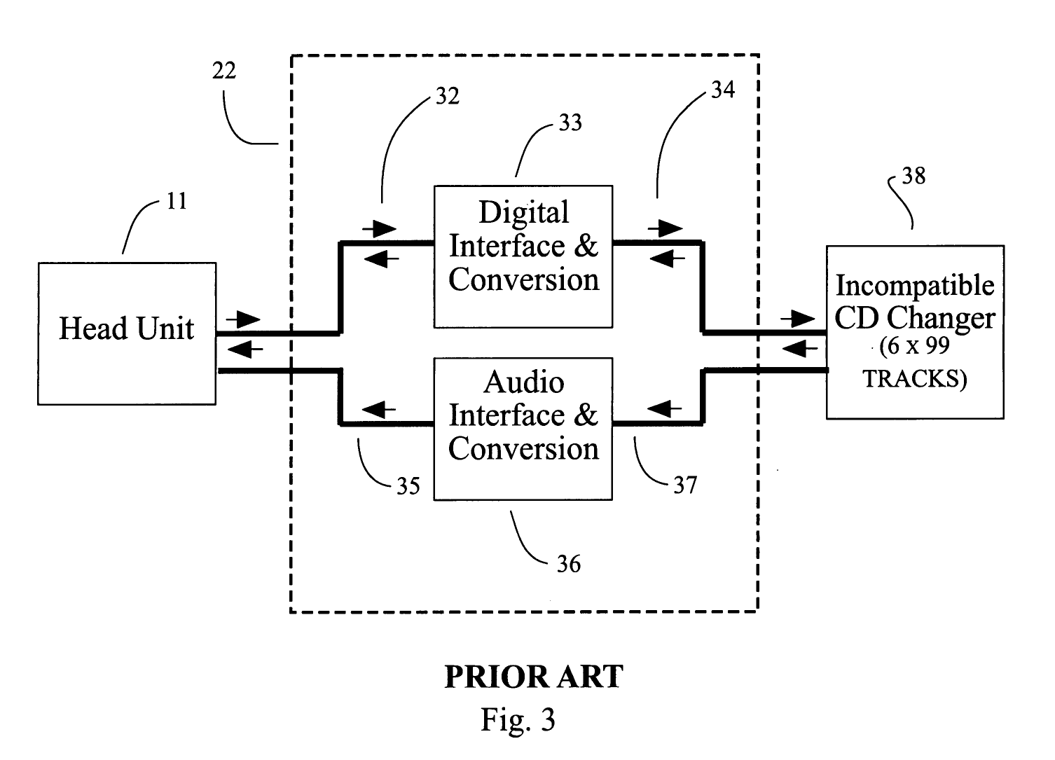

FIG. 3 expands upon the functions of the interfacing device such as is exemplified by the present invention. This figure demarcates the distinction between the audio signal pathways 35 and 37 which are usually an analog audio voltage potential signal and the digital interface and conversion function 33 which performs the simultaneous tasks of satisfying the digital control protocol required to employ a given head unit and to enable the remote control of a normally incompatible CD Changer. Digital data communication means between the Head Unit 11 and the interface device 22 relays the digital protocol required by Head Unit 11 to operate a compatible audio device remotely is shown as bus 32 while the digital data communications means 34 provides for the remote control of the normally incompatible audio player 38 according to its own digital protocol.

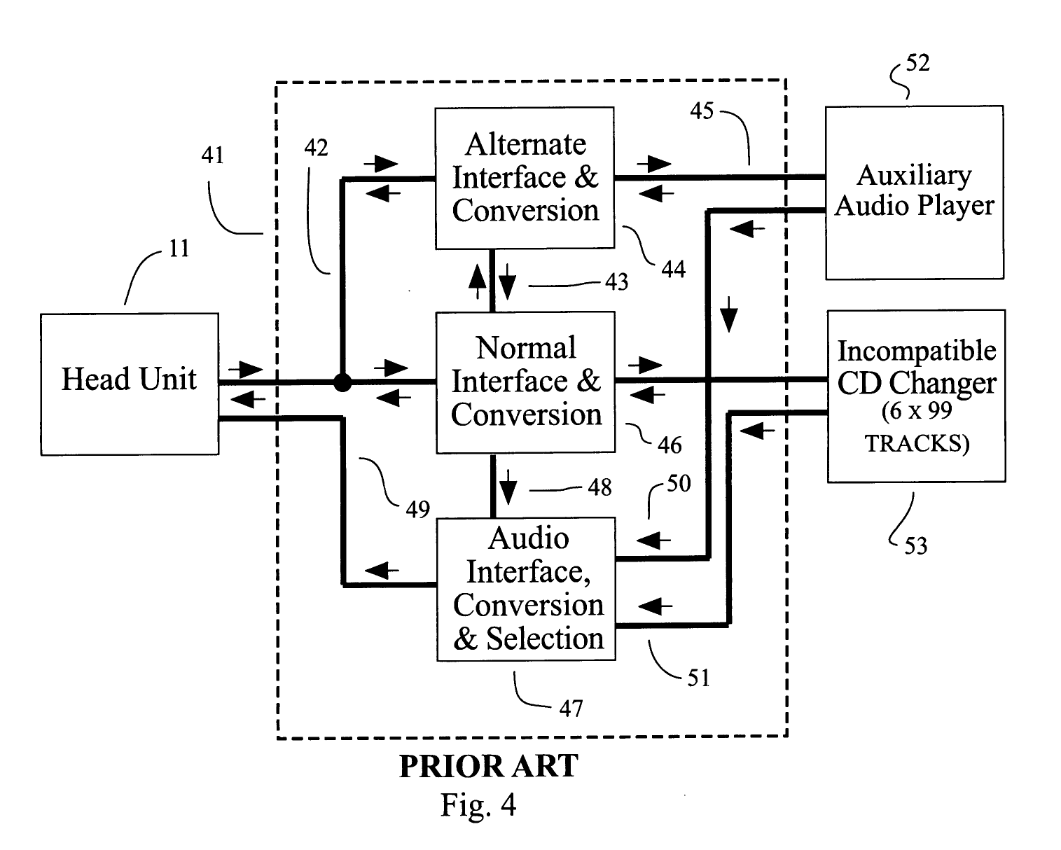

FIG. 4 illustrates the system as described by Blitzsafe in their patent application number 2003/0215102. In particular, Blitzsafe describes the interposition of alternate interface and conversion functions for physically separate audio players, each of which are able to be controlled without any enhancement of the digital protocol requirements of the user interface device. Blitzsafe therefore describes the provision for the limited extension of the digital protocol of a given user interface device for the purpose of specifying which of a number of different audio players are engaged. As illustrated in FIG. 4, the digital protocol necessary to satisfy the remote control protocol requirements as relayed by digital data communication means 42 can be alternately satisfied by the action of a normal interface & conversion protocol conversion function 46, or alternatively, at least one alternate interface & conversion protocol conversion function 44. Blitzsafe describes the user's entry of a rapid track up and track down command in rapid succession as relayed by the user input device to enable the selection of different audio players by the subsequent entry of a disc number command corresponding to the particular device to select. Data pathway 43 illustrates control signals necessary to permit the system to pass control of the head unit data bus 42 to either the normal or at least one alternate protocol conversion functions. The selection function is accomplished in the device Blitzsafe describes as a special interpretation of the entry of a sequence such as a track up followed by a track down command and then at least a disc selection. This special interpretation must work regardless of which protocol interface and conversion function is selected, hence, this special selection sequence may be treated as part of each interface & conversion function, and its invocation determines which interface & conversion function is engaged according to signals 43 that result from the user's invocation of that special sequence.

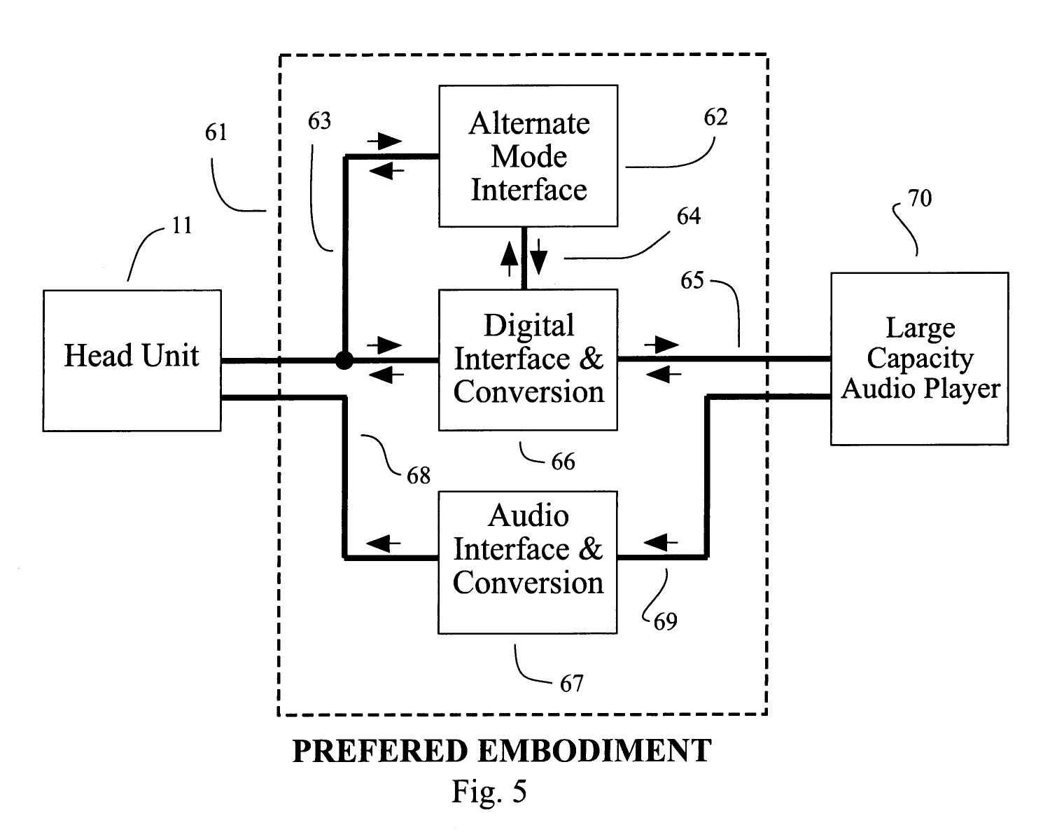

FIG. 5 illustrates the system according to the preferred embodiment of the present invention. It illustrates the use of an alternate interface interpretation function 62 in which a parameter related to the selection of tracks that would normally be beyond the scope of the digital protocol supported by a user interface device such as a car stereo head unit 11 is determined. That data is then, independently supplied by signals 64 to enhance or expand the control of a large capacity audio player 70 by way of the digital data interface means 65.

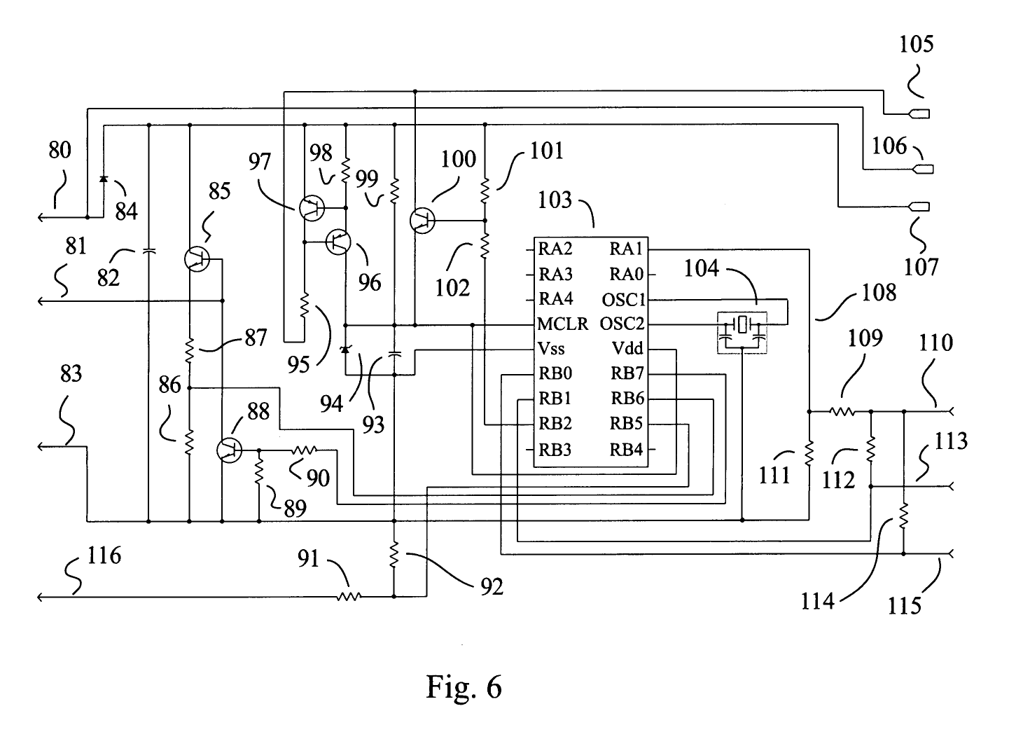

FIG. 6 is illustrative of the digital electronics typical of interfacing a user interface device such as a car stereo head unit to a modern digital audio player. In this case, the circuit shown was developed to provide for a bidirectional protocol as connected to serial data line 81 and simultaneously to provide for a pair of protocol lines, one for data transmission on data line 115 and one for data reception on data line 113. Data received on data line 81 is buffered by transistor 85, and the voltage levels of the digital signal there are translated to be a level compatible with microprocessor 103 by the use of a resistor divider 86 and 86. Microprocessor 103's oscillation frequency is determined by an external resonator 104. Data is transmitted on data line 81 by transistor 88 which is actuated by the microprocessor by way of resistors 89 and 90 in connection with microprocessor 103. Data line 110 is provided for a signal indicative of the connection status of the associated device. Power supply connection 80 is shown for the circuit which was designed for an automotive application. Transistor 100 provides for one method of controlling the increase of current to the microprocessor 103 when it needs to be continuously active, and also for controlling the power to the analog audio interfaces, not shown, by way of the signal 105. Transistor 96 and 97, in conjunction with resistor 98 implement a power supply which provides current to Zener diode 94 when transistor 100 signals that extra power is required. The power supply circuit that includes Zener diode 94 provides exactly the current required to operate microprocessor 103 without sensitivity to the voltage potential of circuit ground 83 as compared to power supply positive voltage potential provided at 80. As a result, the circuit shown provides for a high degree of ground loop noise immunity by effectively isolating the microprocessor circuit 103 from ground potential interference that may be present at 83 with respect to power supply potential 80. This circuit is one embodiment of the invention disclosed in Fiori U.S. Pat. No. RE37,130. This circuit is also useful as it also reliably protects microprocessor 103 from high voltage battery voltage transients that occur on the vehicle power supply bus. Power supply line 107 is a power supply bus provided for the use of circuits in the product and is also protected from damaging negative voltage potentials by the action of diode 84. Vehicle accessory signal 116 is supplied to microprocessor 103 by way of resistors 91 and 92 in order for the system to respond to the drivers engagement of the vehicle accessory power by way of the vehicle's ignition key switch. With this signal microprocessor 103 can control the power consumption and respond appropriately when the driver turns accessories on and off.

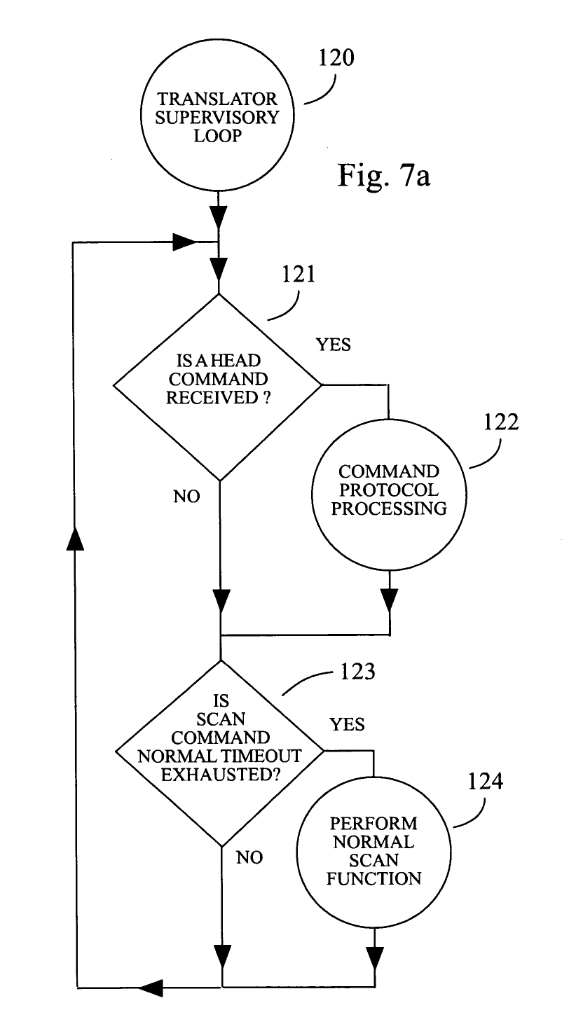

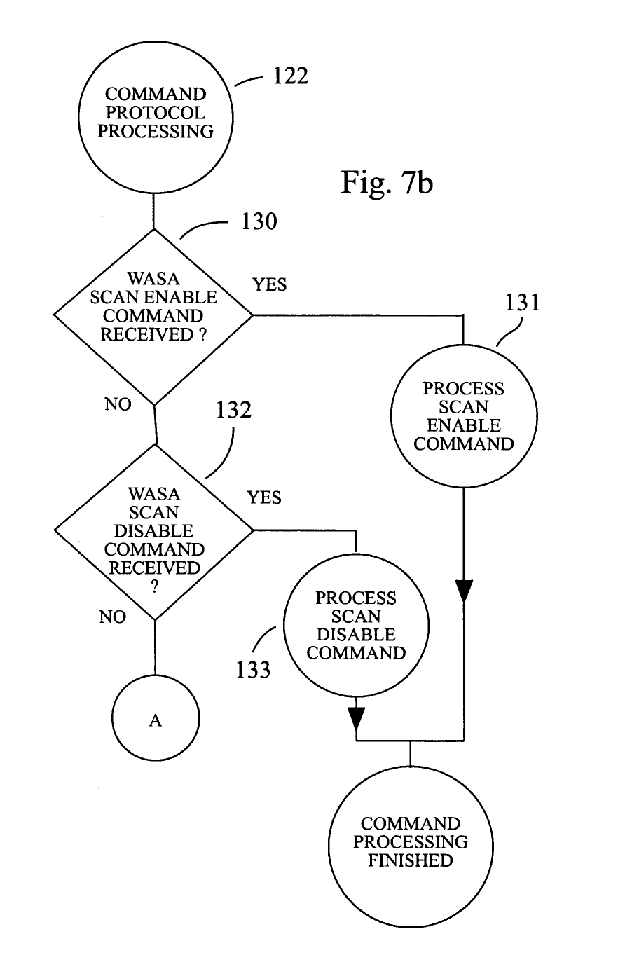

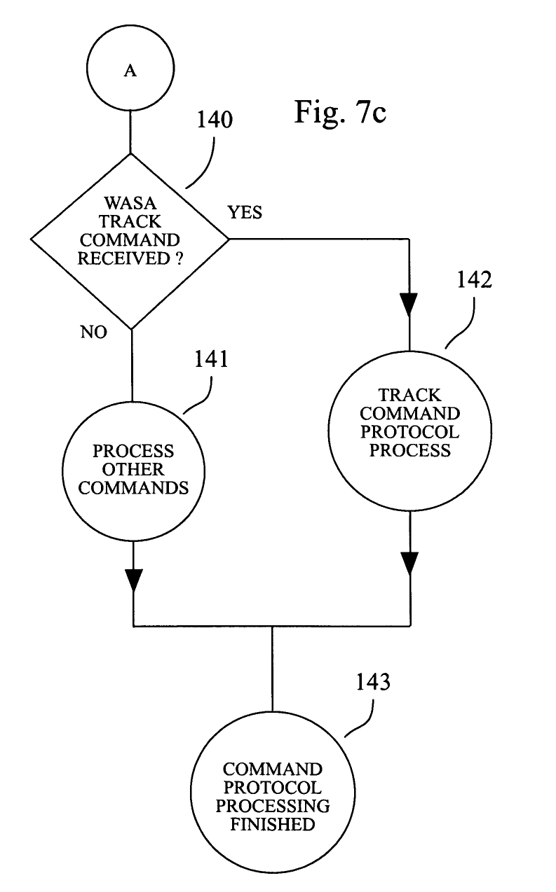

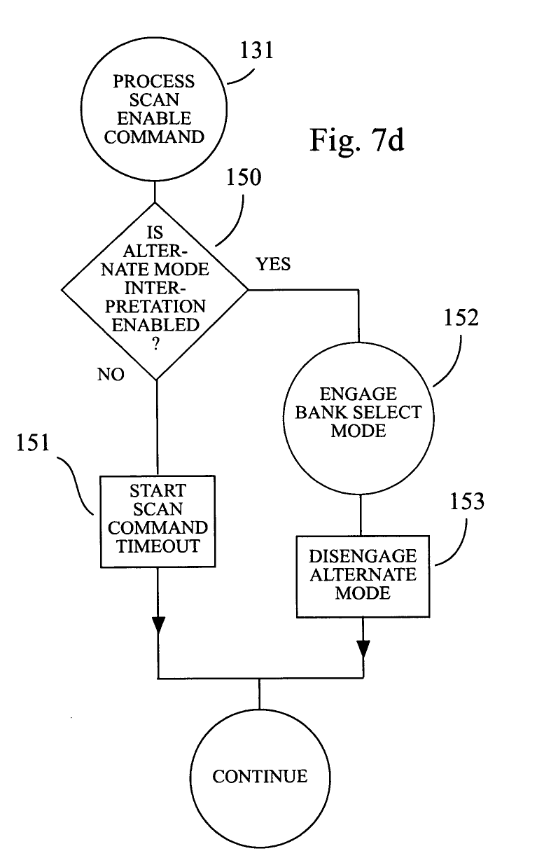

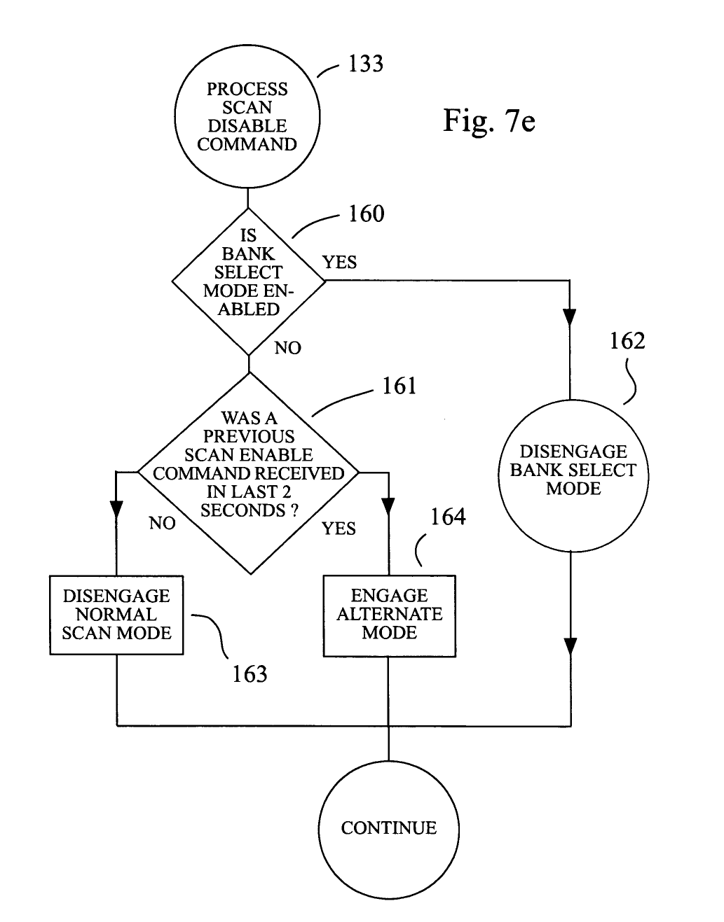

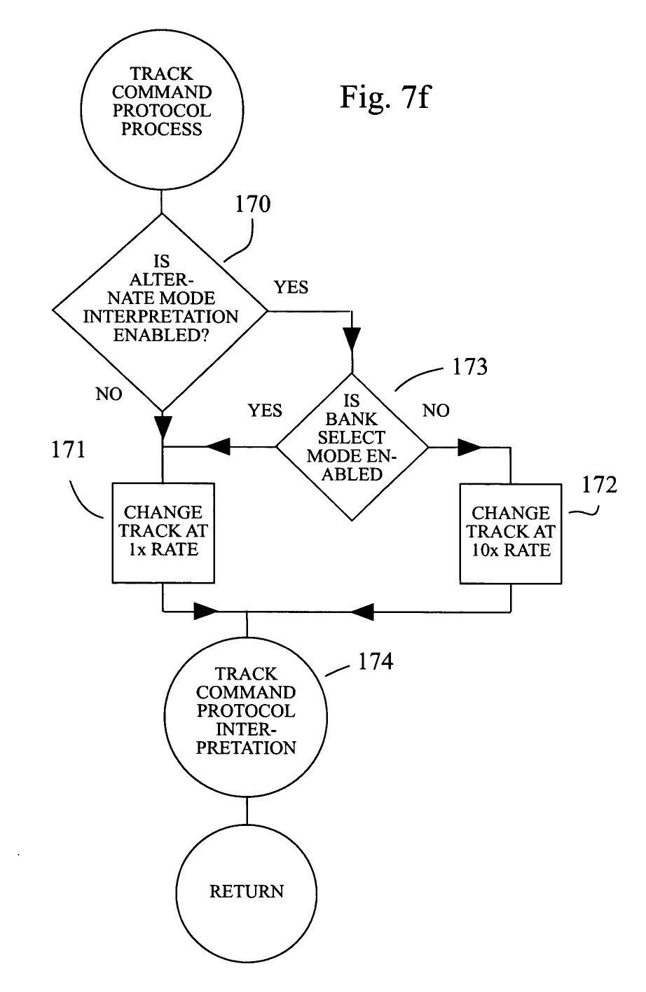

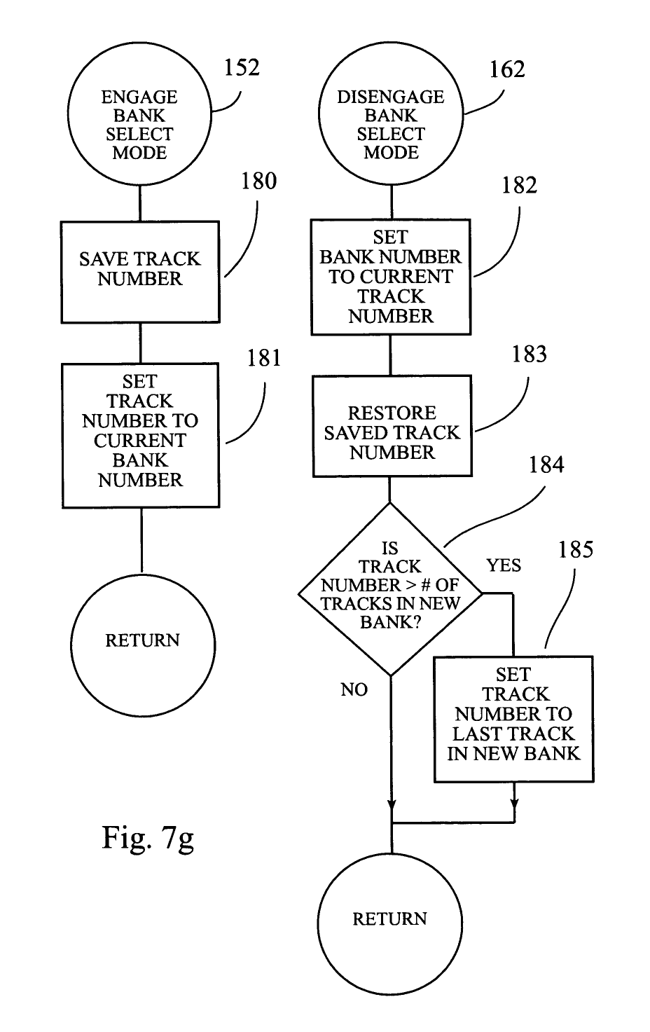

FIGS. 7a through 7g depict a flowchart of the preferred embodiment of the present invention. This is the operational flowchart of the salient procedures that describe the preferred embodiment of the current invention. It features the fundamentals of the logic necessary to interpret the quick succession of a user interface button, which, in this case is the “scan” toggle function of a typical car stereo head unit, to enter an alternate interpretation mode which is, in this instance, described as a “Bank Select Mode”. In this mode the normal user interface track selection protocol is used to select an offset into a much larger field of possible selections than the normal user interface protocol can allow. As far as the user is concerned, they would just treat what would otherwise be the selection of a track number as a bank number. When this alternate mode is exited, the corresponding offset would be applied to enable the selection of a possible new set of tracks beginning from that offset. That offset would then be added to the normal track mode specifications subsequently entered by the user.

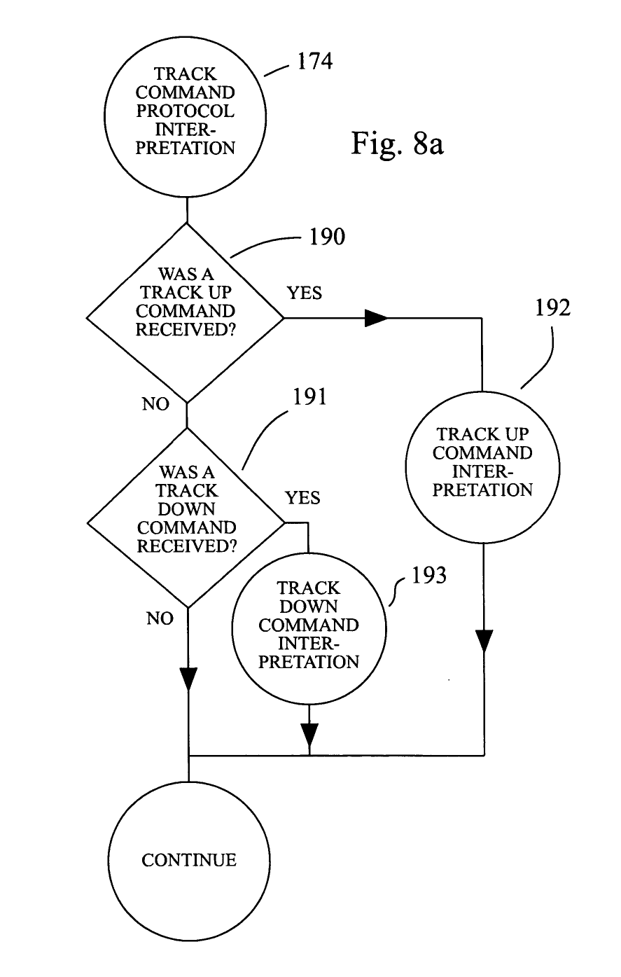

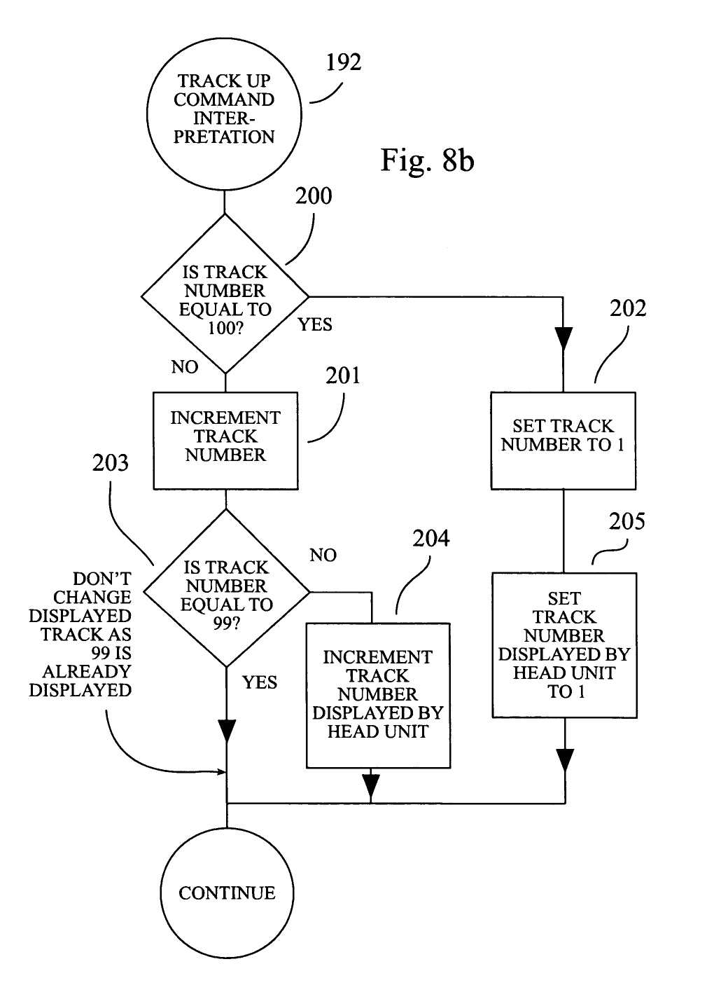

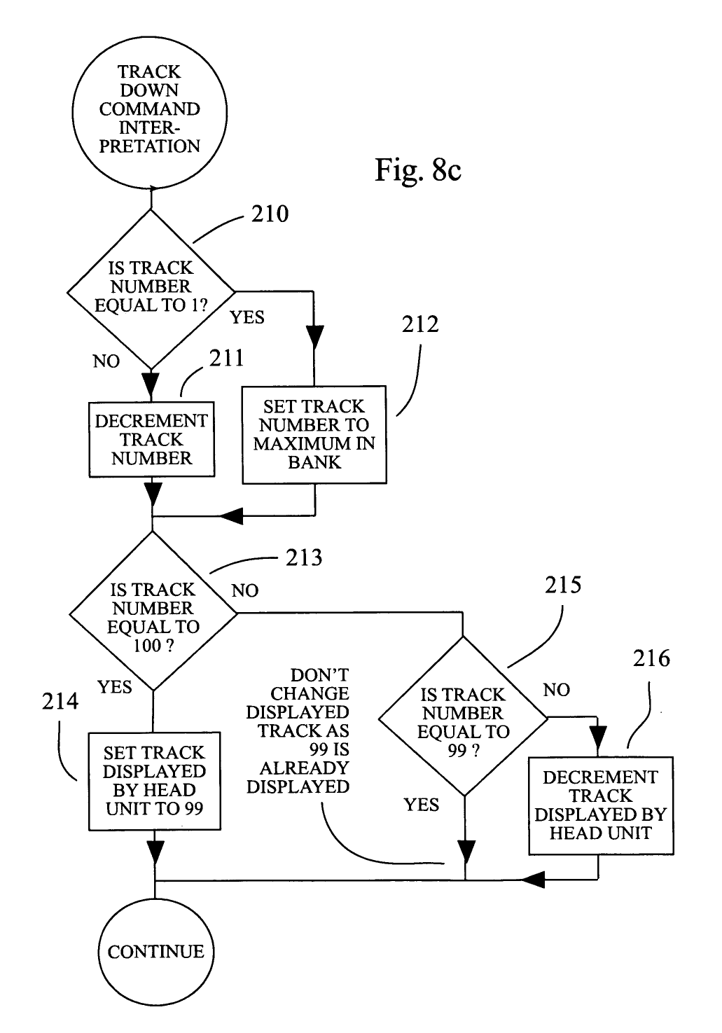

FIG. 8a through 8c constitute a flowchart of track command protocol interpretation that can realize the doubling of states so that the selection of up to 100 tracks is possible with track command protocol that can only provide for the selection of 99 tracks.

Referring now to the drawings, wherein like reference numerals refer to the same components across the several views and in particular to FIG. 5, the normal user interface device protocol 63 can be interpreted either by the normal digital and interface conversion function 66 or the alternate mode interface function 62 according to control signals 64. Either interface function is able to satisfy the digital protocol requirements of the user interface device 11.

The interface function is in control of the single user interface data link 63 and is determined by control logic associated with the detection of the rapid succession of scan toggle function commands while the normal digital and interface conversion function 66 is in control. In the preferred embodiment track change rate is modified to ten (10) times the normal change rate when the alternate mode interface function is in control of protocol data signal 63. In addition, when the alternate mode interface function is in control, the receipt of a single scan function command is then interpreted as a bank select mode whereas any further track change specifications are interpreted to effectively change the bank related offset to use when addressing selections from the target remotely controllable device. When the alternate interface function is operating to specify the bank related offset, a subsequent receipt of a scan command will return control of the normal user interface device protocol 63 to the normal digital and interface conversion function 66.

The above control features of the present invention are implemented with the control program logic described in FIG. 7. Program 120, labeled “translator supervisory loop” is the control program that is charged with responding to the user interface device protocol. It is referred to as a loop because program control is repetitively executing and testing for the conditional branches in the loop until one of them diverts program control. It is the control condition testing loop that determines if a command was received from the user interface device in conditional program flow branch 121, and if so, diverts program execution to process the command in program 122. In any event, program 120 also checks the status of a scan command timeout function that is checked after a scan command is entered to actuate the normal scan function if a second scan command is not received within a specified timeout period. A timeout period of from 1-3 seconds has proven to work well in most cases.

When a scan command is first detected by the command protocol processing program at conditional test 130 in FIG. 7b, the normal scan is function is not immediately engaged. Instead the scan process is enabled in program 131. Program 131 starts the start command timeout function in program 151 in FIG. 7d. that is tested in the translator supervisory loop at branch condition 123 shown in FIG. 7a. Then, only if a second scan command is not specified by the time that timeout function expires will the processor execute the normal scan function program 124.

If a second scan command is received before the expiration of the scan timeout function, program 133 is invoked from condition branch 132 in the command protocol processing branch 122 illustrated in FIG. 7b. In this case, when the scan disable command was received before the scan timeout function expired, such as a time of about 2 seconds as described in conditional branch 161 in FIG. 7e, the alternate mode of user interface device interpretation would be engaged in program 164. Once engaged, the alternate mode interpretation mode causes subsequent track change commands to be interpreted at 10 times the change rate as shown in program branch 172 in FIG. 7f. The alternate mode interpretation also causes the subsequent receipt of a scan enable command to engage the bank select mode program 152 instead of restarting the scan command timeout as shown in FIG. 7d.

When bank select mode engagement program 152 is performed, the current normal mode track number is saved in program 180, and it is then substituted for with the current bank number instead by the action of program 181. In this way the same program that manages the user interface device track change protocol can continue to be used without altering the register assignments of the track number values in the microprocessor implementing the present control logic.

While in bank select mode, the invocation of a track command will result in a track change rate that is the normal 1 times rate. This is accomplished with conditional logic branch 173 in FIG. 7f which restores the normal 1 times rate effected by program 171 when the system is in the bank select mode of the alternate interpretation mode.

In a corresponding way, when the user subsequently toggles the scan mode off, select disengagement program 162 in FIG. 7e is performed as the result of a branch to the scan disable command process 133 in conditional branch 132 of FIG. 7b. When so invoked, the bank select mode disengagement program 162 set the bank number to the then current track number developed by the protocol to that point in program 182 in FIG. 7g, and the restores the track number in program 183 that was stored away in program 180 when bank select mode was engaged by program 152. In the event the previous track number is too large to apply to the number of tracks in the bank just selected, conditional branch 184 diverts the control procedure to set the track number to the last track number in that bank.

The preferred embodiment also implements the track state doubling principle of track value interpretation as illustrated in FIGS. 8a-8c. These programs are invoked in the track command protocol process program 142 in FIG. 7f. After the new track number values are determined in programs 171 or 172, the values arrived at are processed by the track command protocol interpretation program 174.

FIG. 8a expresses the track command protocol interpretation which must perform differently depending on the direction of the track change. Program 192 is applied if the track command specified a track increment, and program 193 is applied if the track command specified a decrement in track. FIG. 8b expands program 192, and FIG. 8c expands upon program 193.

Program 192 first checks if the previous track number is equal to 100 in conditional branch 200. If the previous track number was 100, the program sets the new track number to 1 as the logic implements a wrap feature. Once so determined, the interface then is directed to transmit a track number of 1 to the user interface device in program 205 in FIG. 8b. If the previous track was not equal to 100, a normal track number increment is effected in program 201. Afterwards, if the new track number is equal to 99, the displayed track number is not changed to effect the double use of that user interface display state. If the new track number is not equal to 99, then the track number is normally incremented and the user interface display is directed to display the new value in program 204 in FIG. 8b.

Program 193 first checks if the track number was previously equal to 1 in conditional branch 210. If the previous track number was equal to 1, the new track number is set to the last track number in the currently selected bank in program 212 in FIG. 8c. Otherwise, the track number is normally decremented in program 212. Then, since it is possible that the new track number set to be equal to the last track number in the currently selected bank can be 100 as determined by conditional branch 213 in FIG. 8c, a value that most user interface devices designed for CD changers cannot display, the system directs the user interface display to display the value 99, and this display therefore corresponds to the second of the two track number states that share that displayed value. If the track number is not equal to 100 as determined by conditional branch 213 in FIG. 8c, the track number is then compared to 99 in conditional branch 215. If it is 99, then the display is not changed since it should have already been displaying the second of the two track number states and now will be displaying the first of the two track number states that share the displayed value of 99. If the track number is determined not be 99 in conditional branch 215, the decremented track number value previously determined is directed to be display by the user interface device in program 216 of FIG. 8c.

In view of the foregoing disclosure, some advantages of the present invention can be seen. For example, a novel interface enhancement apparatus has been described. The novel interface enhancement apparatus allows the ordinary translation of the digital control protocols employed by ordinary head units to control CD changers to provide for specifying or displaying the large number of tracks that such new types of audio players are able to select. Additionally, the present invention could also be applied to utilizing the track control protocol to select among multiple auxiliary audio players.

While the preferred embodiments of the present invention have been described and illustrated, modifications may be made by one of ordinary skill in the art without departing from the scope and spirit of the invention as defined in the appended claims. For example, an alternative function mode in which the user may select an offset when they select what the user interface device would ordinarily treat as a track selection might be immediately entered upon the entry into alternate function interpretation mode without requiring the user interface to submit yet another command in the sequence. Because the display would not be displaying the normal parameter associated with that function, such a scheme would tend to preclude the use of the normal parameter selection capabilities of the user interface device for other purposes such as the more rapid changing of that normal parametric value.

What is claimed is:

1. A digital interface translating device that enhances the control scope of a user interface device comprising:
at least one processor executing a control program that satisfies the normal digital protocol requirements of a given user interface device;
said processor that executes said control program that is able to detect a special sequence of commands to enable an alternative mode for at least one alternate interpretation of said normal digital protocol requirement of said given user interface device and that uses said normal user interface device digital protocol to determine the value of a given parameter in addition to those normally provided for by the normal digital user interface device protocol; and
said processor executing a second control program that is able to satisfy the digital protocol requirements of at least one remotely controllable target device, said processor using said given parameter to control said remotely controllable target device in an enhanced manner not normally possible with the normal interpretation of said user interface device digital protocol.

2. The device according to claim 1, wherein:
said control program that uses said given parameter determined in said alternate mode to specify one of a set of offsets to be added to the normal mode parameter to yield a further parameter.

3. The device according to claim 1, wherein said control program modifies the interpretation of at least one user interface device protocol command that applies to a parameter whose value is able to be specified by the normal user interface device protocol, but modifies said parameter in a manner different from that normally applied to said parameter by said user interface device after said digital interface translating device detects said special sequence.

4. The device according to claim 3, wherein said control program uses said given parameter determined in said alternate mode to specify an offset to be added to the normal mode specification of a related parameter to yield a parameter, to yield a new parameter that specifies a larger scope than the normal mode protocol of the user interface device is capable of specifying.

5. The device according to claim 1 wherein said at least one processor executes a control program that is able to specify the selection, and to satisfy the digital protocol of more than one remotely controllable target device; said at least one processor further executing a control program that is able to detect a special sequence of commands, different from said sequence of commands so as to enable a different alternative mode for an additional alternate interpretation of said normal user interface device protocol, and which uses said normal user interface device digital protocol to determine the value of at least a second given parameter, said second parameter specifying which of more than one remotely controllable target device is to be selected.

6. The device according to claim 2, where the control program that uses one state of the user interface program that ordinarily specifies at least one state of one parameter to indicate two states of said at least one parameter as it is applied to said target interface.

7. The device according to claim 6, wherein the at least one processor executes a control program that is able to specify the selection and to satisfy the digital protocol of more than one remotely controllable target device; said at least one processor executing a control program that is able to detect a special sequence of commands, different from said sequence of commands so as to enable a different alternative mode for an additional alternate interpretation of said normal user interface device protocol, and which uses said normal user interface device digital protocol to determine the value of at least a second given parameter, said second given parameter specifying which of more than one remotely controllable target device is to be selected.

8. The device according to claim 1 wherein said alternative mode for at least one alternate interpretation of said normal user interface device protocol, that is enabled by a special sequence comprised of the rapid succession of two function commands, that when normally interpreted by said normal user interface, would ordinarily only momentarily enable the corresponding normal function.

9. The device according to claim 8, wherein said at least one processor executes a control program that is able to specify the selection and satisfy the digital protocol of more than one remotely controllable target device, and further executing a control program that is able to detect a special sequence of commands, different from said sequence of commands so as to enable a different alternative mode for an additional alternate interpretation of said normal user interface device protocol and which uses said normal user interface device digital protocol to determine the value of at least a second given parameter, said second parameter specifying which of more than one remotely controllable target device is to be selected.

10. The device according to claim 2, wherein said alternative mode for at least one alternate interpretation of said normal user interface device protocol is enabled by a special sequence comprised of the rapid succession of two function commands that when normally interpreted by said normal user interface would ordinarily only momentarily enable the corresponding normal function.

11. The device according to claim 10, wherein said control program that uses one state of the user interface program that ordinarily specifies at least one state of one parameter to indicate two states of said at least one parameter, as it is applied to said target interface.

12. The device according to claim 11, wherein the at least one processor executes a control program that is able to specify the selection and satisfy the digital protocol of more than one remotely controllable target device; and further executes a control program that is able to detect a special sequence of commands, different from said sequence of commands so as to enable a different alternative mode for an additional alternate interpretation of said normal user interface device protocol and that uses said normal user interface device digital protocol to determine the value of at least a second given parameter, said second parameter specifying which of more than one remotely controllable target device to select from.

13. The device according to claim 1, further comprising: at least one power supply circuit configured to provide the current required to operate at least one circuit part without sensitivity to connected signal ground potential of said circuit part.
